(19) United States
(12) Patent Application Publication
(10) Pub. No.: US 2005/0220294 A1
(43) Pub. Date: Oct. 6, 2005

(54) Push-button hinge for handheld devices

(75) Inventor: Sheel A. Gupte, Buffalo Grove, IL (US)

Correspondence Address: GREER, BURNS & CRAIN, 300 S WACKER DR, 25TH FLOOR, CHICAGO, IL, 60606, US

(73) Assignee: Amphenol-T&M Antennas

(21) Appl. No.: 11/050,634

(22) Filed: Feb. 2, 2005

Related U.S. Application Data
(60) Provisional application No. 60/541,169, filed on Feb. 2, 2004.

(51) Int. Cl. H04M 1/00; H04M 9/00

(52) U.S. Cl. 379/433.13

(57) ABSTRACT

A push-button hinge for a handheld device. The hinge comprises an axially movable button having a push surface and a helical portion for converting axial movement of the button to rotation, a helical follower engaged with the helical portion for rotating in response to the axial movement of the button, a cam rotatably movable with a flip part of the handheld device, a cam follower engaged with a cam profile of the cam and rotatably movable with the helical follower, and a biasing member for urging the cam against the cam follower. The cam profile includes an area initially resisting opening of the handheld device that is overcome by rotation of the cam follower in response to the axial movement of the button. The cam profile further includes a slope for causing rotation of the cam with respect to the cam follower due to the biasing member, thus rotating the flip part and opening the handheld device.

### PRIORITY CLAIM

This application claims the benefit of U.S. Provisional Application Ser. No. 60/541,169, filed Feb. 2, 2004, under 35 U.S.C. §119.

### BACKGROUND OF THE INVENTION

A field of the invention is handheld devices, e.g., handsets and personal digital assistants (PDA's), portable gaming devices, etc. The invention particularly concerns flip-style handheld devices.

Due to size and aesthetic benefits, for example, flip-style housings are popular for a wide range of small portable handheld devices, such as PDA's, handsets (e.g., mobile phones), portable gaming devices, etc. Such flip-style devices are very popular because they form a convenient shape, and the flip-style devices have proven to be aesthetically pleasing to a large segment of the consumer market. When closed, the flip-style devices provide a small device footprint, making the storage of the device in a pocket, on a clip, in a holder, in a briefcase, in a purse, or a drawer, etc., very convenient.

A flip-style device generally requires a hinge connecting what may be considered a main part and a flip part of the handheld device. The hinge provides controlled relative movement between the main part and the flip part. Typical hinges provide initial resistance to movement of the flip part from either a fully open or a fully closed position of the flip-style device when a user opens a flip part of a device. Hinges typically are also biased to remain in the fully open and fully closed positions.

A hinge used to form a connection in a handheld device such as a flip-style device is in a very demanding environment. Operational cycles are high frequency, meaning that users of flip-style and other hinged handheld devices open and close the device frequently. In the example of a flip-style mobile phone, a user commonly opens and closes the device with each use of the device. The hinge in a flip-style device must also provide a smooth and controlled operation, and should be biased to remain in respective open and closed positions. There is considerable interest, however, in keeping the hinge simple and as inexpensive as possible. The handheld device market is extremely competitive, and component expenses thus should be kept as low as possible.

A push-button hinge provides an attractive alternative to a typical hinge that is opened by a physical manipulation of the flip part of the device. The push-button hinge further provides a convenient one-handed mechanism to open a flip-style device, which may be awkward with conventionally hinged flip-style devices.

Achieving push-button operation should not, however, result in an overly complex or expensive hinge. Cost, simplicity, ease of assembly and small size are omnipresent concerns in the design and manufacture of hinges for flip-style devices. Another concern is the ability to separately manufacture the hinges as self-contained units that can be readily assembled to other components of flip-style devices.

### SUMMARY OF THE INVENTION

Preferred embodiments of the present invention provide a push-button hinge for a handheld device. The hinge comprises an axially movable button having a push surface and a helical portion for converting axial movement of the button to rotation, a helical follower engaged with the helical portion for rotating in response to the axial movement of the button, a cam rotatably movable with a flip part of the handheld device, a cam follower engaged with a cam profile of the cam and rotatably movable with the helical follower, and a biasing member for urging the cam against the cam follower.

The cam profile includes an area initially resisting opening of the handheld device that is overcome by rotation of the cam follower in response to the axial movement of the button. The cam profile further includes a slope for causing rotation of the cam with respect to the cam follower due to the biasing member, thus opening the handheld device.

### BRIEF DESCRIPTION OF THE DRAWINGS

FIG. 1 is an exploded perspective view of a push-button hinge for a handheld device, according to a preferred embodiment of the present invention;

FIG. 2 is a perspective view of an assembled push-button hinge according to FIG. 1;

FIG. 3 is a cutaway perspective view of an assembled push-button hinge according to FIG. 1;

FIG. 4 is an assembled and partially transparent perspective view of a handheld device having the push-button hinge of FIG. 1;

FIG. 5 is a perspective view of a button according to the embodiment of FIG. 1;

FIG. 6 is a bottom plan view of the button of FIG. 5;

FIG. 7 is a side elevation view of the button of FIG. 5;

FIG. 8 is a perspective view of a helical follower according to the embodiment of FIG. 1;

FIG. 9 is a side elevation view of the helical follower of FIG. 8;

FIG. 10 is a sectional view of the helical follower of FIG. 9, taken along line 10-10 and in the direction indicated;

FIG. 11 is a perspective view of a button guide according to a preferred embodiment of the present invention;

FIG. 12 is a perspective view of a cam according to the embodiment of FIG. 1;

FIG. 13 is a top plan view of the cam of FIG. 12;

FIG. 14 is a side elevation view of the cam of FIG. 12;

FIG. 15 shows a cam profile of the cam of FIG. 12;

FIG. 16 is an assembled and partially transparent perspective view of a portion of the handheld device of FIG. 4, showing an opening operation of a push-button hinge; and

FIG. 17 is an assembled and partially transparent perspective view of a portion of the handheld device of FIG. 4, showing an additional phase of operation of the push-button hinge.

### DETAILED DESCRIPTION

A push-button hinge for a handheld device is provided by the invention. Preferred embodiments of the push-button hinge are self-contained; that is, the hinge preferably can be used in different devices, and operation of the hinge can be independent of a particular handheld. It is also preferred that the push-button hinge provide a low part count. Exemplary embodiments of the invention also use a minimal number of expensive parts.

Preferred embodiments of the present invention provide, among other benefits, a relatively simple design including a limited number of required parts. The assembly can also be made relatively simple. In preferred embodiments, a larger allowable spring length is provided than conventional push-button hinges, because a spring can be disposed nearly along the complete length of the hinge. Additionally, a preferably larger cam profile surface than conventional push-button hinges provides reduced wear during use.

Further, by providing a single cam profile, the effective cam surface is lengthened (preferably doubled), and thus the wear life on the surface of the cam profile is lengthened. In prior push-button hinges, by contrast, respective profiles of nested cams were disposed generally about half of the cam diameter surface, increasing wear.

Previous push-button hinges have included nesting cams and cam followers. A latch mechanism has been used to secure the hinge (and thus the handheld device) in an open or closed position. According to preferred embodiments of the present invention, by providing a button having a helical portion and a single cam profile, nested cams and nested cam followers can be avoided. The number of biasing members (e.g., springs) necessary preferably can be reduced as well. These differences lower the number of parts required for a push-button hinge (by more than half in preferred embodiments compared to some conventional hinges), and they simplify manufacture of the individual parts and the assembly of the complete hinge. In preferred embodiments, plastic and/or diecast metal parts may be used, further simplifying manufacture.

Further, a latch mechanism preferably is not necessary to retain the handheld device in an open or closed position. By eliminating the need for a latch mechanism, the handheld device can be partially opened without requiring that the device be opened completely to close the device.

Some preferred embodiments of the invention will now be discussed with reference to the figures. Artisans will appreciate that the figures are presented schematically and are not necessarily to scale. The features may be exaggerated for the purposes of illustration.

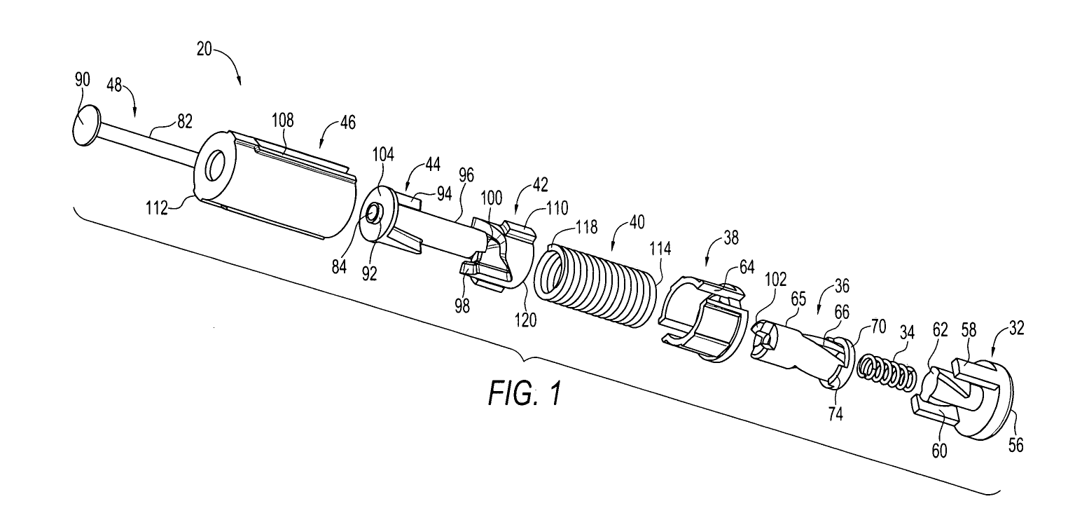

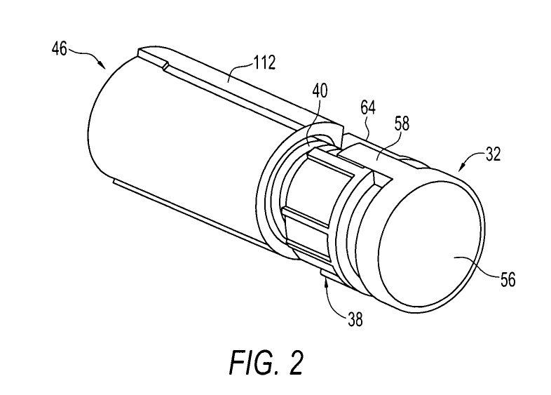

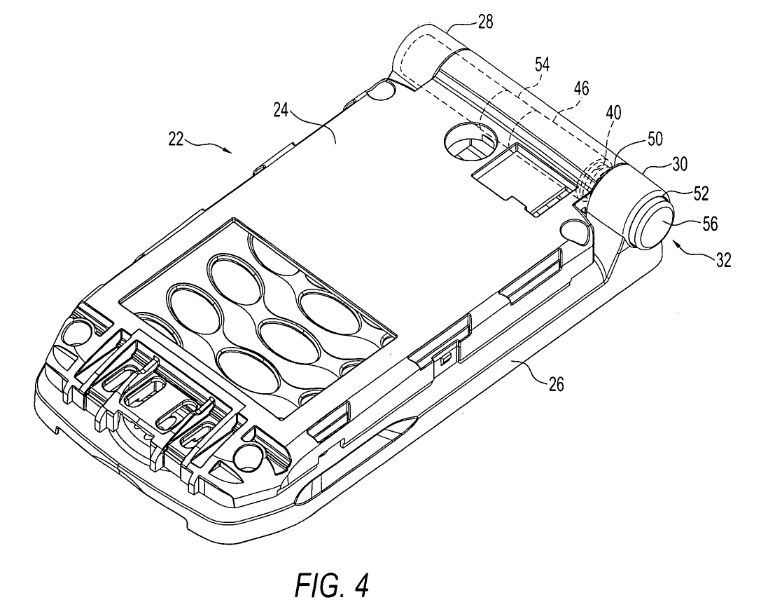

Referring now to the drawings, FIGS. 1-4 show an exemplary self-contained push-button hinge 20 for handheld flip-style devices. The hinge 20 preferably is accommodated in a hinge location of a handheld device 22 between a flip part 24 and a main part 26. For example, as shown in FIG. 4, the hinge 20 is disposed between a pair of knuckles 28, 30 of a base of a mobile phone. The base forms the main part 26 of the phone. The knuckles 28, 30 are incorporated into the main part 26, and part of the hinge 20 is fitted into one of the knuckles (as shown, the right knuckle 30). This knuckle 30 is open at both ends so that a button 32 of the hinge 20 can project from the knuckle for operation. The handheld device 22 includes an interface to the hinge 20.

A relatively small number of parts (in this embodiment, nine) are used in the exemplary hinge 20, thus reducing fabrication costs, simplifying assembly, and increasing durability for high-frequency use. Generally, and referring to FIG. 1 particularly, the hinge 20 includes the button 32, an inner or button biasing member 34, a helical follower 36, a button guide 38, an outer or main biasing member 40, a cam 42, a cam follower 44, a can 46, which also provides an interface with the handheld device 22, and a rivet 48. As referred to herein, the terms “frontward” refers to the axial direction toward the button 32. The term “rearward” refers to the opposing axial direction.

As shown in FIG. 4, the button guide 38 is fixed within the knuckle 30 of the handheld device 22, and preferably is press-fit within the knuckle. Accordingly, the button guide 38 preferably is constrained from axial or rotational movement with respect to the main part 26 of the handheld device 22. The button guide 38 preferably is made of diecast metal.

The knuckle 30 containing the button guide 38 has opposing open ends, so that the hinge 20 extends from an inwardly-facing end 30 (as shown, the left) of the knuckle while the button 32 projects from the opposing, outwardly-facing (right) end 52 for operation by a user. The length of the main biasing member 40 extends through an opening 54 of the handheld device 22 or between the main part 26 and the flip part 24.

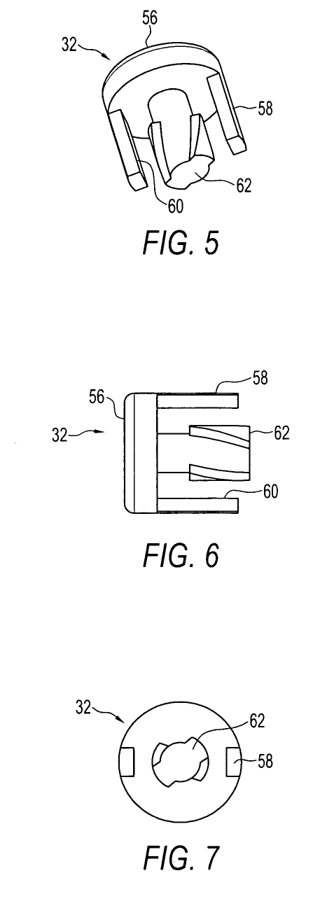

Referring to FIGS. 5-7, the button 32, also preferably made of diecast or injection molded metal, includes a push surface 56, a pair of diametrically opposed, axially extended legs 58 having a generally flat inner face 60, and a centrally disposed helical middle 62. The legs 58 engage mating grooves 64 in the button guide 38, so that the button 32 is restricted from rotational movement, but can move axially in either direction with respect to the button guide.

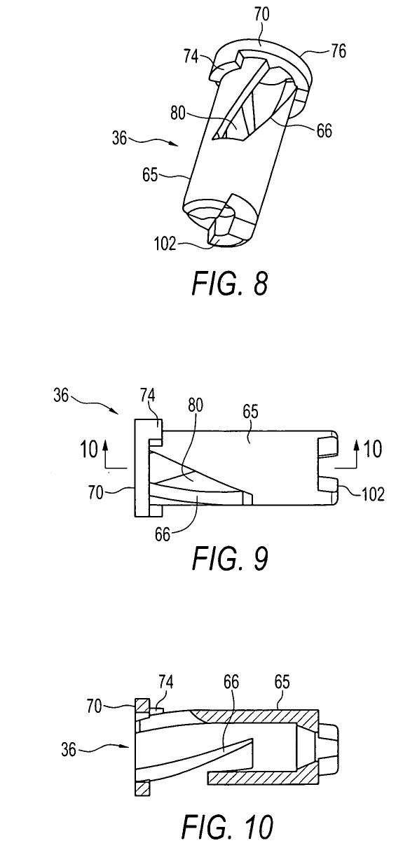

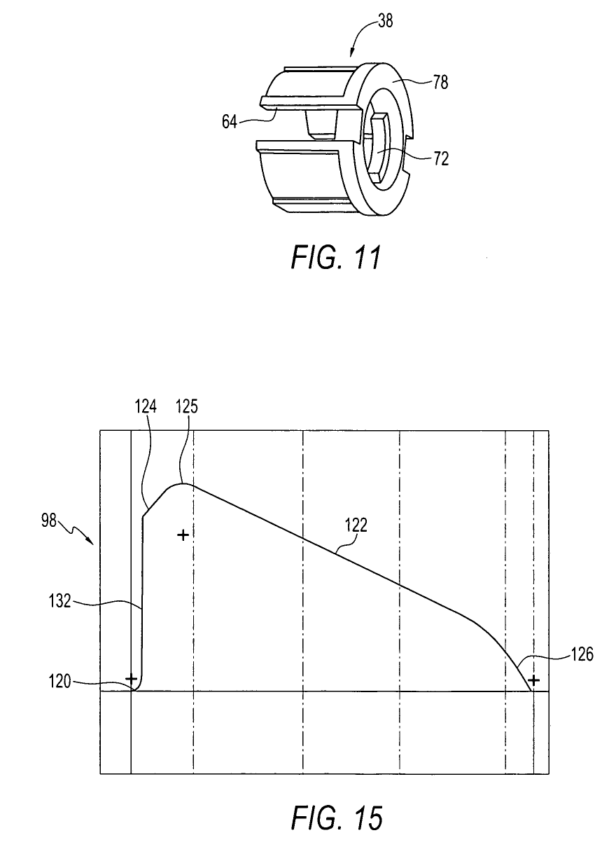

The helical middle 62 preferably includes a low-angle double helix, which converts axial movement of the button 32 to rotation of the helical follower 36. The helical follower 36 (FIGS. 8-10), preferably made from diecast metal or injection molded metal, includes a shaft 65 having a centrally disposed helical cutout 66, which engages the helical middle 62. As the helical middle 62 travels axially within the helical cutout 66, it rotates the helical follower 36. However, the helical follower 36 is restricted from axial movement with respect to the button guide 38 (and thus with respect to the knuckle 30 of the handheld device 22).

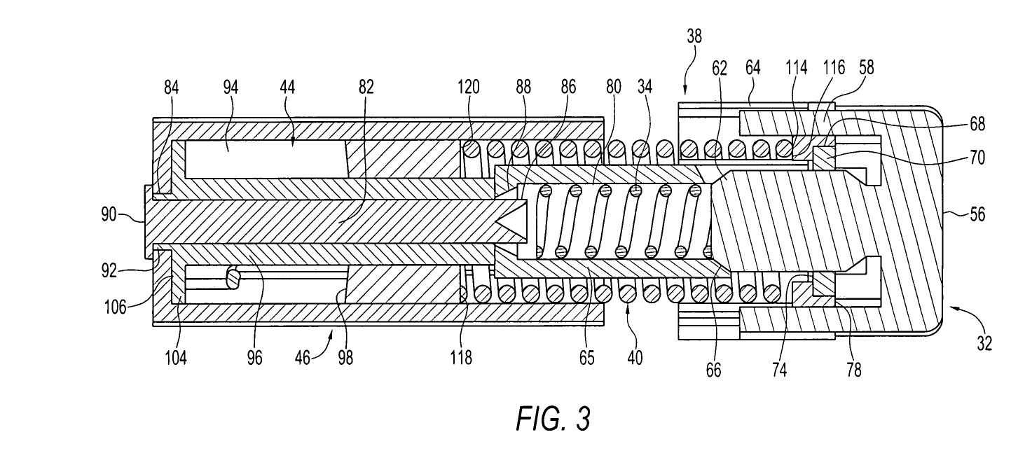

A rotational limiter is provided in a seat 68 of the button guide 38, so that a head 70 of the helical follower 36, which sits within the seat, is limited from complete rotation. The seat 68 preferably includes a reduced diameter area within the button guide 38. In a preferred embodiment, the rotational limiter is in the form of a pair of symmetrically arranged sectors 72, which respectively mate with a pair of rearward facing, symmetrical sectors 74 of the head 70. The shaft 65 of the helical follower can rotate within the button guide 38 until the sectors 74 engage the sectors 72. Preferably, rotation of the shaft 65 is limited to about 30 degrees within the button guide 38. It is preferred that the head 70 be disposed within the seat 68 so that a front surface 76 of the helical follower is substantially flush with a front surface 78 of the button guide 38 (see FIG. 3).

The button biasing member 34, such as a spring, is disposed within a central passage 80 of the helical follower 36. A spring, for example, may be a standard or otherwise formed part. By engaging a rearward surface of the helical middle 62, the button biasing member 34 provides a continuous outward biasing force on the button 32, urging it outward (as shown). This helps the button 32 to release from an inward position after it is released by a user. Accordingly, the user presses the button 32 against the urging of the button biasing member 34 when activating the hinge 20. Because the helical middle 62 is engaged with the helical follower 36 as described above, outward movement of the button 32 as a result of urging from the button biasing member 34 causes rotation of the helical follower in a rotational direction opposite to that when the button is pressed inward by a user (until the helical follower engages the rotational limiter 72).

The cam follower 44 is secured to the helical follower 36, for example using a fastener such as the rivet 48. In a preferred embodiment, a shank 82 of the rivet 48 extends axially through a central passage 84 within the cam follower 44. A head 86 of the rivet 48 engages an inner end 88 of the helical follower 36 to rivet the helical follower with the cam follower 44. The rivet 48, made of a strong material (e.g., brass or steel), preferably provides the backbone of the hinge 20. An opposing head 90 of the rivet 48 abuts a circular projecting outer end 92 of the cam follower 44. As shown in FIG. 3, the outer end 92 projects rearward of the can 46 so that the opposing head 90 (and thus the cam follower 44 and helical follower 36) can rotate with respect to the can. In a preferred assembly method for the hinge 20, the rivet 48 is punched from the helical follower side until the head 86 engages and enters the inner end 38 of the helical follower 36.

The cam follower 44, preferably made of diecast metal, includes an opposing pair of generally rounded engaging members, preferably lobes 94, radially projecting from outer surfaces of a central cylindrical shaft 96 through which the rivet 48 extends. The lobes 94 follow a cam profile 98 (cam profile surface) of the cam 42. Front sectors 100 engage mating sectors 102 of the helical follower 36 to limit respective rotation, so that the helical follower and the cam follower 44 rotate as a single piece. A base 104 of the cam follower 44 abuts a back wall 106 of the can 46, and the outer end 92 projects rearward from the base. The base 104 and the remainder of the cam follower (including the projecting outer end 92 and the rivet 48 abutting thereto) are free to rotate with respect to the can 46, though rotation is constrained by the cam 42 as well as rotational constraints on the connected helical follower 36. Similarly, the can 46, rotationally movable with the flip part 24 of the handheld device 22, is able to rotate about the shaft 96 of the cam follower 44. The cam follower 44, being fastened to the helical follower 36, is constrained from axial movement with respect to the can 46, and with respect to the handheld device 22.

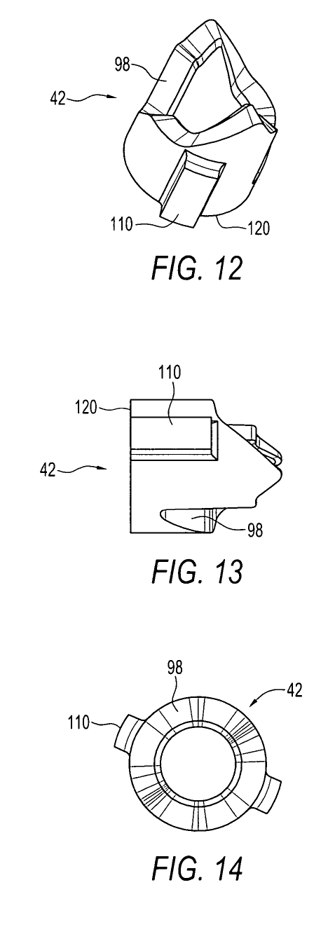

The cam 42 (see FIGS. 12-14), preferably made of diecast metal, plastic, or injection molded metal, can move axially with respect to the can 46 and with respect to the cam follower 44. Preferably, the can 46 also is made of diecast metal, plastic, or injunction-molded metal, and is a generally cylindrical shaped piece. The can 46 preferably includes inner axial tracks 108 within which opposing keys 110 of the cam 42 engage, so that the cam moves axially forward and rearward with respect to the can 46, but so that it rotates with the can. The can 46 includes a pair of projecting outer keys 112, which preferably have interior surfaces serving as the inner axial tracks 108. One or both of the keys 112 engage one or more interfaces, such as keyways (not shown) of the flip part 24 of the handheld device 32 disposed between the knuckles 28, 30, so that the can 46 rotates with the flip part. Particularly, rotation of the can 46 results in rotation of the flip part 24 about the hinge 20. Alternatively, the keys 110 of the cam 42 may directly engage keyways of the flip part 24. However, in this alternative embodiment, the portion of the flip part 24 securing the cam 42 should be constructed of wear-resistant material to withstand high-frequency opening and closing of the handheld device 22.

The cam 42 rotates with respect to the cam follower 44, and preferably about the shaft 96 of the cam follower. Accordingly, the cam 42 rotates with respect to the button guide 38. The cam 42 also moves axially on the shaft 96 of the cam follower 44.

The main biasing member 40 may be, for example, a spring that is a standard or otherwise formed part. A front end 114 of the main biasing member 40 preferably is disposed between a rearward facing surface 116 of the sectors 72 of the button guide 38. A back end 118 of the main biasing member engagingly abuts a frontward facing surface 120 of the cam 42, and follows the cam as it rotates. Thus, the main biasing member 40 is constrained axially by the button guide 38 at the front end 114 and by the cam 42 at the back end 118. As opposed to some conventional push-button hinges, the preferred embodiment hinge 20 provides a member for urging the cam 42 and the cam follower 44 that is allowed to extend over a large amount of the hinge (see FIG. 3).

For example, prior to the present preferred hinge(s), a separate mechanism was provided axially between a push-button and a cam follower, reducing the available axial length for extending the spring. Particularly, in some conventional push-button hinges, lobes of a cam follower would be disposed axially on a button side of the hinge. Because the lobes of a cam follower could not be at the end of the button guide, but instead needed to be further along the hinge, this cam follower placement reduces the effective length of the main biasing member (the member biasing the cam against the cam follower). By contrast, in the preferred hinge 20, the cam follower 44 is disposed axially on the rearward side, substantially opposite axially from the button 32. In this way, the effective length of the main biasing member 40 can extend through the knuckle 30 of the handheld device 22 (where the button guide 38 ends).

The main biasing member 40 preferably can rotate with respect to the cam 42, and may slip. The cam 42, on the other hand, is axially constrained by the back end 118 of the main biasing member 40 and by the lobes 94 of the cam follower 44 engaging the cam profile 98. The main biasing member 40 provides a continuous biasing force on the cam 42 to urge the cam, particularly the cam profile 98, against the lobes 94 of the cam follower 44. This biasing force causes the flip part 24 to open by causing rotational movement of the cam 42 due to engagement of the cam profile 98 with the lobes 94.

Engagement of the cam profile 98 with the lobes 94 provides controlled rotation of the cam follower 44 and the cam 42. FIGS. 12-14 show an exemplary cam 42, and FIG. 15 shows an exemplary cam profile 98 that engages one of the lobes 94. The cam profile 98 shown in FIG. 15 is from 0-180 degrees about the mean diameter of the cam 42, and it is repeated from 180-360 degrees. Due to the larger allowable main biasing member length provided by preferred embodiments of the present invention, and thus the larger allowable deflection, the cam profile 98 can extend higher than some conventional push-button hinges. This larger cam profile 98 provides higher torque for rotating the flip part 24 of the handheld device 22.

Some conventional push-button hinges having nested cams and cam followers use about half of the complete radial space available for the nested cams. In preferred embodiments of the hinge 20, however, substantially the complete radial surface of the cam profile 98 engages the lobes 94. In this way, the surface of the cam profile 98 is more resistant to wear during high-frequency use.

As shown in FIG. 15, the preferred cam profile 98 shown includes a valley 120, a descending (negative) slope 122, a nub 124 near a peak 125 of the slope, and a drop-off (larger negative slope) 126 near the bottom of the slope. It is contemplated that other cam profiles, varying in shape and/or proportion, may be used to control rotation of the cam follower 44 and/or rotation of the cam 42. When the flip part 24 is closed, the lobes 94 engage the nub 124 of the cam profile 98. Most opening and closing of the handheld device occurs as the lobes 94 follow the slope 122 (including the drop-off 126). When the flip part 24 is fully opened, after the drop-off 124 is engaged, the lobes 94 engage the valley 120 of the cam profile 98, and further (forward) travel along the profile is then restricted.

When the lobes 94 engage the long descending slope 122, the flip part 24 can be manually opened (thus moving the lobes back to the nub 124) or closed (thus moving the lobes to the valley 120). As opposed to some conventional push-button hinges, therefore, a handheld device having the preferred hinge # can be opened or closed directly, even when the device is partially open. In other push-button hinges, for example, an integrated latch may need to activated (such as by fully opening the device) to allow closing of the handheld device.

In a preferred assembly method of the hinge 22, the cam follower 44 is inserted within the can 46 until the projecting end 92 extends through the aperture at the back wall 106 of the can. The rivet 48 is threaded from the back through the cam follower 44. The cam 42 is then placed inside the can 46 around the shaft 96 of the cam follower 44. Separately, the helical follower 36 and the button guide 32 are assembled so that the head 70 of the helical follower engages the seat 68. The main biasing member is placed over the cam 42, and the helical follower is placed over the head 86 of the rivet 48, compressing the main biasing member between the cam and the button guide 36. The rivet 48 is punched, holding the hinge 20 together.

The button guide 38 is pressed axially against the main biasing member 40 until the sector 72 passes the sector 74 of the helical follower 36 in the axial direction. This allows the button guide 38 to rotate beyond the normal (about 30 degree), limited rotation resulting from engagement of the sectors 72, 74. The button guide 38 is manually rotated such that both the helical middle 62 and the helical cutout 66 are aligned, and such that the legs 58 are aligned with the guides 64.

The button 32 is pressed to force relative rotation of the helical follower 36 and the button guide 38, until the button guide rotates (in a direction opposite to the previous manual rotation) and then moves axially away from the main biasing member (toward the button 32). When the sector 72 axially engages the head 70 of the helical follower 36, further axial movement is halted, completing the assembly. The button 32 remains engaged with the hinge 20 due to the helical engagement with the helical follower 36, the sectors 72, 74, which limit rotation of the helical follower with respect to the button guide, and the guides 64, which restrict rotational movement of the button with respect to the button guide.

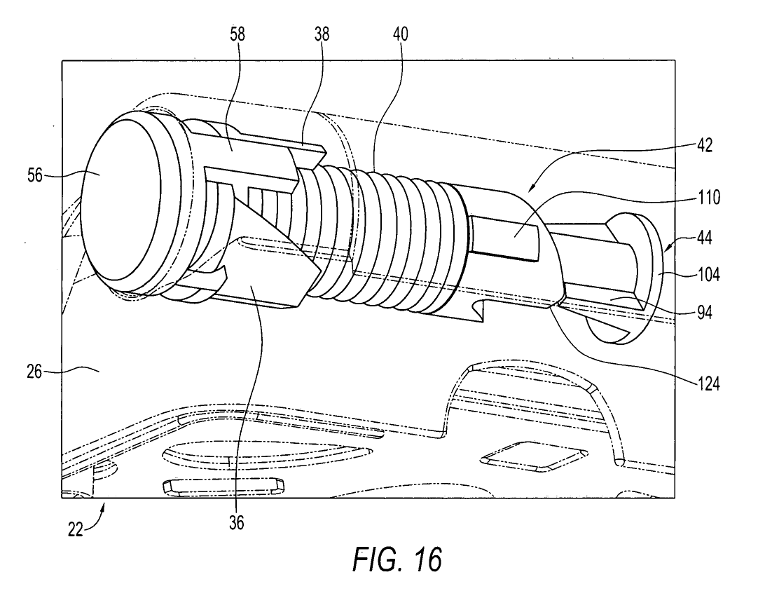

In a preferred operation for opening the hinge 20, and referring first to FIG. 16, showing the handheld device 22 in a closed position, the button 32 is depressed. The axial movement of the button 32 with respect to the button guide 38 rotates the helical follower 36, and thus the connected cam follower 44. However, the cam 42 initially does not move (or moves very little), as it is connected to the can 46 and thus the closed flip part 24. Pushing the button 32 thus produces relative rotational motion between the cam follower 44 and the cam 42. Because the lobes 94 engage the nubs 124 when the handheld device 22 is closed, rotation of the lobes 94 along the cam profile 98 initially closes the handheld device even further, though this rotational motion is restricted due to the interface between the hinge 20 and the handheld device. The button 32 is depressed until the cam follower 44 overrides the cam 42; that is, until the lobes 94 travel over and past the peak 125 of the cam profile 98. The cam follower rotation required to override the cam 42 preferably is about 10-15 degrees from the initial location at a closed position. The force required is provided by the mechanical advantage obtained due to the helical angle between the helical follower 36 and the button 32.

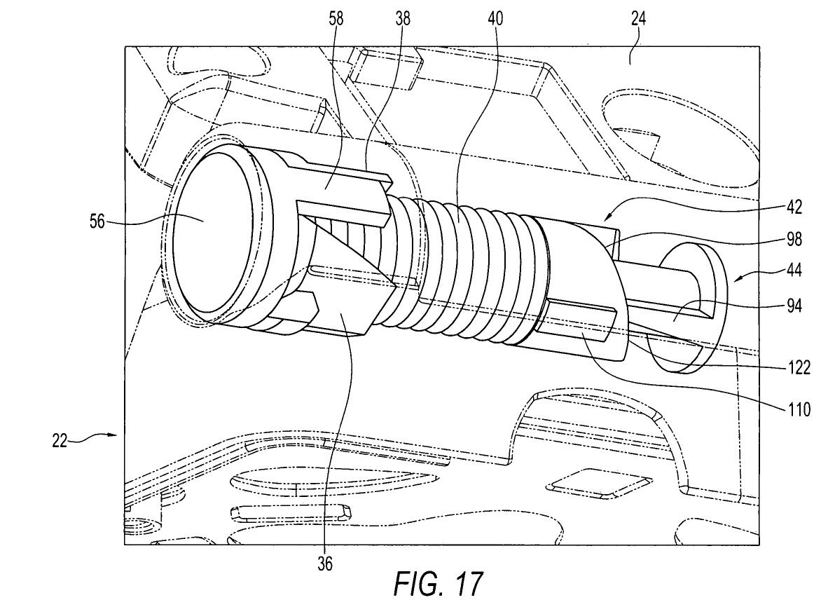

Once the lobes 94 pass the peak 125 and engage the slope 122, the biasing force provided by the main biasing member 40 (urging the cam profile 98 against the lobes) rotates the cam 42 (see FIG. 17). The angle of the cam profile 98 in combination with this biasing force provides the necessary torque to rotate the can 46 and thus the flip part 24, which opens the handheld device 22.

After the flip part 24 opens, the lobes 94 engage the drop-off 126, which provides an additional torque to maintain the handheld device 22 in the open position. As the lobes 94 now engage the valley 120 of the cam profile 98, preferably slightly before a sharp left edge 132 of the vertical slope 122, they are prevented from further rotation in this direction. During or after the flip part 24 opening, the button biasing member 34 causes the button 32 to move outward, which rotates the helical follower 36 and the cam follower 44 slightly in the opposite direction.

To manually close the handheld device 22, the flip part 24 is manually rotated to a closing position with respect to the main part 26. This rotates the can 46 and thus the cam 42 (or only the cam if the can is omitted), which due to the biasing force of the main biasing member 40 moves the lobes 94 along the slope 122 of the cam profile 98 in the reverse direction (in FIG. 4, to the left). The lobes 94 follow the cam profile 94 until the peak 125 is reached and passed, at which time the lobes engage the nub 124 (without falling to the valley 120). At this point, the handheld device 22 is closed, and the hinge 20 is ready for opening by depressing the button 32. The cam follower 44 provides closed bias torque, because the follower lobes 94 are on a negative slope in the closing (left) direction.

As the lobes 94 travel along the slope 122, and accordingly when the handheld device 22 is partially open or closed, the flip part 24 can be manually moved to an open or closed position. This is accomplished by rotating the flip part so that the lobes 94 follow the slope either past the peak 125 or to the drop-off 126. Because the lobes 94 follow the same cam profile 98 when opening the handheld device (left to right), it is not necessary to activate a latch to perform this operation. In some conventional push-button hinges, separate cam profiles were provided for manual and push-button operation, and thus an integrated latch was necessary to allow push-button operation.

A hinge 20 has thus been shown and described. Various cam profiles can achieve differently natured operations. The preferred embodiment hinge operation is completely reversible at any point in its fully or partially open position. It permits standard style opening (grabbing the flip part) as well as push-button operation. In the preferred embodiment shown, only nine parts are used. In additional embodiments, the can 46 may be omitted depending upon the nature of the device into which the hinge 20 is to be inserted. A high cycle embodiment of the invention that will stand rigorous operation preferably uses only three metal injection molded parts: the can 46, the button guide 38, and the cam follower 44. The rivet 48 and the biasing members 34, 40 may be a standard die-cast or otherwise formed part, and the remaining parts may be molded plastic, for example. The hinge 20 preferably is self-contained and may be pre-assembled, making incorporation into a handheld device straightforward.

While specific embodiments of the present invention have been shown and described, it should be understood that other modifications, substitutions, and alternatives are apparent to those of ordinary skill in the art. Such modifications, substitutions, and alternatives can be made without departing from the spirit and scope of the invention, which should be determined from the appended claims.

Various features of the invention are set forth in the appended claims.

1. A push-button hinge for a handheld device comprising:
an axially movable button having a push surface and a helical portion for converting axial movement of the button to rotation;
a helical follower engaged with the helical portion for rotating in response to the axial movement of said button;
a cam rotatably movable with a flip part of the handheld device;
a cam follower engaged with a cam profile of said cam and rotatably movable with said helical follower;
a biasing member for urging said cam against said cam follower;
the cam profile including an area initially resisting opening of the handheld device that is overcome by rotation of said cam follower in response to the axial movement of said button, the cam profile further including a slope for causing rotation of said cam with respect to said cam follower due to said biasing member, thus rotating the flip part and opening the handheld device.

2. The push-button hinge of claim 1 further comprising:
a button guide fixed with respect to a main part of the handheld device and engaged with said button so as to permit axial movement of said button but constrain rotation of said button.

3. The push-button hinge of claim 2 wherein said helical follower is disposed within said button guide, and wherein said button guide includes a rotational limiter for limiting rotation of said helical follower within said button guide.

4. The push-button hinge of claim 2 wherein said biasing member extends between said button guide and said cam.

5. The push-button hinge of claim 1 further comprising:
a fastener for securing said cam follower to said helical follower.

6. The push-button hinge of claim 5 wherein said fastener comprises a rivet secured to said cam follower and said helical follower.

7. The push-button hinge of claim 6 wherein said cam follower is rotationally locked with said helical follower so that said cam follower and said helical follower rotate together.

8. The push-button hinge of claim 1 further comprising:
a can engaged with said cam, said can being rotatably movable with said cam, said cam being axially movable within said can.

9. The push-button hinge of claim 8 wherein said can is engaged with the handheld device so that rotation of the cam rotates the can, which rotates the flip part of the handheld device.

10. The push-button hinge of claim 1 wherein said cam is rotatable about an axially extending shaft of said cam follower.

11. The push-button hinge of claim 10 wherein lobes of said cam follower engage the cam profile.

12. The push-button hinge of claim 11 wherein the lobes comprise a pair of lobes symmetrically disposed about the shaft of said cam follower.

13. The push-button hinge of claim 12 wherein the pair of lobes engage a single cam profile such that a substantially complete radial surface of the cam profile is engaged with the pair of lobes during opening of the handheld device.

14. The push-button hinge of claim 1 further comprising:
a button biasing member for biasing said button outward.

15. The push-button hinge of claim 1 wherein the area of the cam profile overcome by said cam follower comprises a nub near a peak of the cam profile.

16. A push-button hinge for a handheld device comprising:
an axially movable button including means for converting axial movement of the button to rotation;
means for rotating in response to the axial movement of said button;
single cam profile means for rotating a flip part of the handheld device;
cam follower means engaged with a cam profile of said single cam profile means and rotatably movable with said means for rotating;
means for biasing said cam against said cam follower;
the cam profile including an area initially resisting opening of the handheld device that is overcome by rotation of said cam follower means in response to the axial movement of said button, the cam profile further including a slope for causing rotation of said single cam profile means with respect to said cam follower means due to said means for biasing, thus rotating the flip part and opening the handheld device.

17. The push-button hinge of claim 16 further comprising:
fixed means for constraining rotation of said button.

18. The push-button hinge of claim 17 wherein said fixed means for constraining includes means for limiting rotation of said means for rotating.

19. The push-button hinge of claim 17 wherein said means for biasing extends between said means for constraining and said single cam profile means.

20. The push-button hinge of claim 16 wherein the cam profile engaged with said cam follower means extends substantially about a complete rotation of said single cam profile means.

21. A push-button hinge for a handheld device comprising:
an axially movable button having a push surface and a helical portion for converting axial movement of the button to rotation;
a button guide fixed with respect to a main part of the handheld device and engaged with said button so as to permit axial movement of said button but constrain rotation of said button;
a button biasing member for biasing said button outward;
a helical follower engaged with the helical portion for rotating in response to the axial movement of said button;
a cam rotatably movable with a flip part of the handheld device;
a cam follower engaged with a cam profile of said cam and rotatably movable with said helical follower;
a biasing member for urging said cam against said cam follower;
the cam profile including an area initially resisting opening of the handheld device that is overcome by rotation of said cam follower in response to the axial movement of said button, the cam profile further including a slope for causing rotation of said cam with respect to said cam follower due to said biasing member, thus rotating the flip part and opening the handheld device.

22. A handheld device comprising:
a main part;
a flip part;
a push-button hinge engaged with said flip part, the push-button hinge comprising:
an axially movable button having a push surface and a helical portion for converting axial movement of the button to rotation;
a helical follower engaged with the helical portion for rotating in response to the axial movement of said button;
a cam rotatably movable with said flip part;
a cam follower engaged with a cam profile of said cam and rotatably movable with said helical follower;
a biasing member for urging said cam against said cam follower;
the cam profile including an area initially resisting opening of the handheld device that is overcome by rotation of said cam follower in response to the axial movement of said button, the cam profile further including a slope for causing rotation of said cam with respect to said cam follower due to said biasing member, thus opening said flip part.

23. The handheld device of claim 22 further comprising:
a button guide fixed with respect to said main part device and engaged with said button so as to permit axial movement of said button but constrain rotation of said button.

24. The handheld device of claim 23 wherein said button guide is fixed within a knuckle of said main part, and wherein said cam is disposed between said main part and said flip part.

25. The handheld device of claim 24 further comprising:
a can engaged with said cam, said can being engaged with and rotatably movable with said flip part, said cam being axially movable within said can.
